(19) United States
(12) Patent Application Publication
(10) Pub. No.: US 2020/0286402 A1
(43) Pub. Date: Sep. 10, 2020

(54) METHOD AND SYSTEM FOR ASSISTING WITH MATH PROBLEM

(71) Applicant: HANGZHOU DANA TECHNOLOGY INC., Zhejiang (CN)

(72) Inventors: Tao HE, ZHEJIANG (CN); Fan SHI, ZHEJIANG (CN); Huan LUO, ZHEJIANG (CN); Mingquan CHEN, ZHEJIANG (CN)

(73) Assignee: HANGZHOU DANA TECHNOLOGY INC., Zhejiang (CN)

(21) Appl. No.: 16/559,736

(22) Filed: Sep. 4, 2019

(30) Foreign Application Priority Data
Mar. 4, 2019 (CN) 201910158424.3

(51) Int. Cl. G09B 19/02; G06N 3/08; G09B 7/00; G06K 9/32

(52) U.S. Cl. CPC G09B 19/025; G06N 3/08; G06K 2209/01; G06K 9/325; G09B 7/00

(57) ABSTRACT

A system and method for assisting with a math problem includes: acquiring an image including at least a first question of the math problem; identifying a first region in the image where the first question is located based on the image; identifying characters in the first region based on the first region so as to obtain the first question; determining a type of the first question based on the first question; if the type of the first question is a calculation question, generating a first answer and a step-by-step problem solving process of the calculation question; and displaying the first question and/or the first region, the first answer and the step-by-step problem solving process.

### CROSS-REFERENCE TO RELATED APPLICATIONS

This application claims priority to Chinese Patent Application No. 201910158424.3, filed Mar. 4, 2019, the entirety of which is hereby incorporated by reference.

### TECHNICAL FIELD

The present disclosure relates to a method and a system for assisting with a math problem.

### BACKGROUND

In recent years, artificial intelligence has been applied to daily teaching and learning. For example, a test paper or homework may be corrected using an electronic device such as a smartphone. Therefore, there is a need for new technologies.

### SUMMARY

One of aims of the present disclosure is to provide a method and a system for assisting with a math problem.

One aspect of this disclosure is to provide a method for assisting with a math problem. The method may comprise: acquiring, by an image capturing device, an image including at least a first question of the math problem; identifying, by a first computing device and a pre-trained first neural network model, a first region in the image where the first question is located based on the image; identifying, by a second computing device and a pre-trained second neural network model, characters in the first region based on the first region, so as to obtain the first question; determining, by a third computing device and a pre-trained third neural network model, a type of the first question based on the first question; if the type of the first question is a calculation question, generating, by a fourth computing device, a first answer of the calculation question, and generating, by a fifth computing device, a step-by-step problem solving process of the calculation question; and displaying, by a display device, the first question and/or the first region, and displaying, by a display device, the first answer and the step-by-step problem solving process.

Another aspect of this disclosure is to provide a system for assisting with a math problem. The system may comprise: one or more neural network models that are pre-trained; one or more image capturing devices configured to acquire an image including at least a first question of the math problem; one or more computing devices configured to: identify a first region in the image where the first question is located based on at least one of the one or more neural network models and the image; identify characters in the first region so as to obtain the first question based on at least one of the one or more neural network models and the first region; determine a type of the first question based on at least one of the one or more neural network models and the first question; and generate a first answer and a step-by-step problem solving process of the calculation question if the type of the first question is a calculation question, and one or more display devices configured to display the first question and/or the first region, and display the first answer and the step-by-step problem solving process.

Further features of the present disclosure and advantages thereof will become apparent from the following detailed description of exemplary embodiments with reference to the attached drawings.

### BRIEF DESCRIPTION OF THE DRAWINGS

The accompanying drawings, which constitute a part of the specification, illustrate embodiments of the present disclosure and, together with the description, serve to explain the principles of the present disclosure.

The present disclosure will be better understood according the following detailed description with reference of the accompanying drawings.

FIGS. 1A and 1B are diagrams schematically showing display screens of a display device on which methods for assisting with a math problem according to embodiments of the present disclosure is based.

FIG. 2 is a flow chart schematically showing at least a portion of methods for assisting with a math problem according to embodiments of the present disclosure.

FIG. 3 is a flow chart schematically showing at least a portion of methods for assisting with a math problem according to embodiments of the present disclosure.

FIG. 4 is a block diagram schematically showing at least a portion of systems for assisting with a math problem according to embodiments of the present disclosure.

FIG. 5 is a block diagram schematically showing at least a portion of systems for assisting with a math problem according to embodiments of the present disclosure.

Note that, in the embodiments described below, in some cases the same portions or portions having similar functions are denoted by the same reference numerals in different drawings, and description of such portions is not repeated. In some cases, similar reference numerals and letters are used to refer to similar items, and thus once an item is defined in one figure, it need not be further discussed for following figures.

### DETAILED DESCRIPTION

Various exemplary embodiments of the present disclosure will be described in details with reference to the accompanying drawings in the following. It should be noted that the relative arrangement of the components and steps, the numerical expressions, and numerical values set forth in these embodiments do not limit the scope of the present invention unless it is specifically stated otherwise.

The following description of at least one exemplary embodiment is merely illustrative in nature and is in no way intended to limit this disclosure, its application, or uses. It should be understood by those skilled in the art that, these examples, while indicating the implementations of the present disclosure, are given by way of illustration only, but not in an exhaustive way.

Techniques, methods and apparatus as known by one of ordinary skill in the relevant art may not be discussed in detail, but are intended to be regarded as a part of the specification where appropriate.

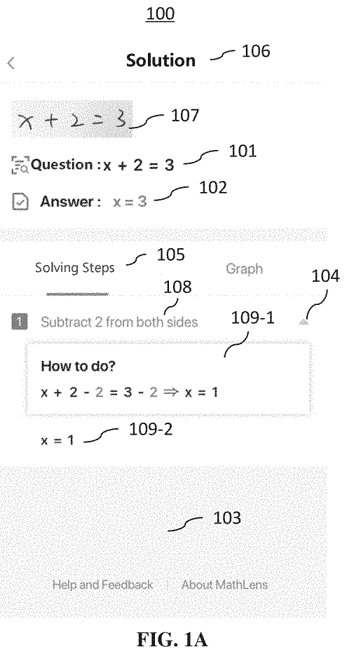

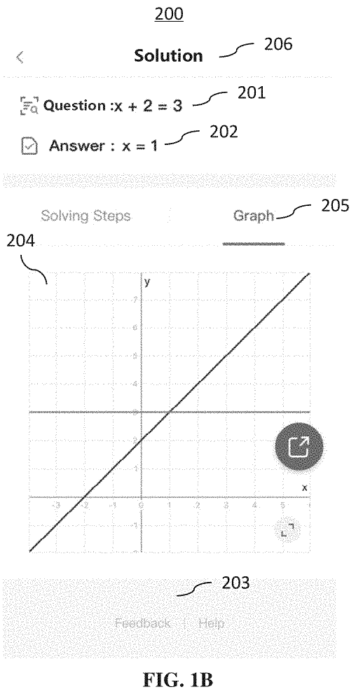

The present disclosure provides a method for assisting with a math problem which may be used, for example, for teaching and learning. A user may use a first electronic device having an image capturing function to take a picture or shoot a video so as to obtain an image of a question of a math problem which needs to be assisted with. The question (may be identified characters of the question and/or the image of the question), an answer and a problem solving process of the question may be displayed on a second electronic device having a display function (the first and second electronic devices may be the same device or may be different devices). In some embodiments, the problem solving process of the question is a step-by-step problem solving process. As shown in FIG. 1A, the user may easily understand the problem solving method through the step-by-step problem solving process. In some embodiments, the problem solving process of the question is a graphical problem solving process. As shown in FIG. 1B, the user may understand the problem solving method from another perspective through the graphical problem solving process. In some embodiments, the methods in the present disclosure may assist with a single question. In some embodiments, the methods in the present disclosure may assist with multiple questions in an entire test paper.

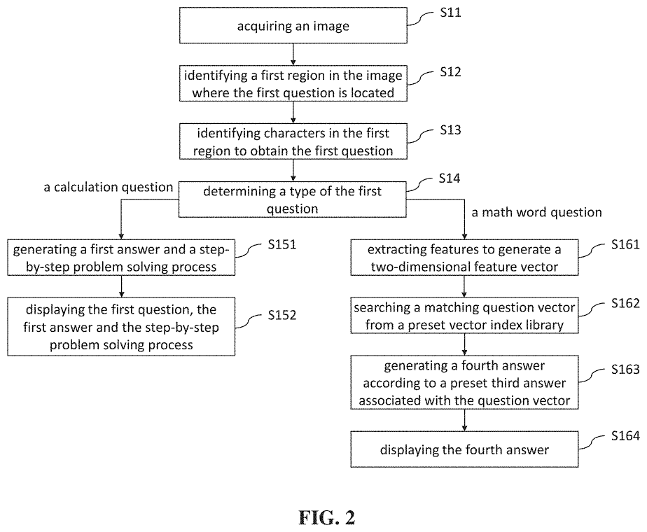

A method for assisting with a math problem and various steps included in the method according to an embodiment of the present disclosure are described below with reference to FIG. 2.

Step S11 may include acquiring an image including at least a first question of a math problem by an image capturing device in the first electronic device. Images may include any form of visual presentation, such as photos or videos. The image capturing device may include a camera, an imaging module, an image processing module and the like, and may also include a communication module or the like for receiving or downloading images. Correspondingly, the image capturing device acquiring the image may include taking a photo or shooting a video, receiving or downloading a photo or video, and the like. The first question in the image may be presented on a first surface. The first surface may include paper (such as for example a test paper, a book or a booklet, etc.), a whiteboard, a chalk board, a display screen (such as a television screen, a computer screen, a pad screen or a learning machine screen, etc.) or various other surfaces.

Step S12 may include identifying, by a first computing device and a pre-trained first neural network model, a first region in the image where the first question is located based on the image. An input of the first neural network model is an image including the first question, and an output is the first region of the image where the first question is located.

The first neural network model may be trained in advance using a large number of training samples, in accordance with the above-described input and output, by any known method. For example, it may be trained by the following process: establishing an image sample training set, wherein each image sample includes at least one question. Labeling each image sample to mark a location of a region in each image sample where the at least one question is located; and training a first neural network through the labeled image sample training set so as to obtain the trained first neural network model. The first neural network may be any known neural network, such as a deep residual network, a recursion neural network, or the like.

Training the first neural network may further include: verifying an output accuracy of the trained first neural network based on an image sample test set; increasing the number of image samples in the image sample training set if the output accuracy is less than a predetermined first threshold, wherein each image sample added to the image sample training set is labeled; and training the first neural network again through the updated image sample training set. The output accuracy of the retrained first neural network is then tested again based on the image sample test set until the output accuracy of the first neural network satisfies the requirement, i.e., not less than the predetermined first threshold. As such, the trained first neural network that meets the requirements for output accuracy may be used as the pre-trained first neural network model in step S12. Those skilled in the art will appreciate that one or more image samples in the image sample training set may be placed into the image sample test set as needed, or one or more image samples in the image sample test set may be placed into the image sample training set as needed.

Step S13 may include identifying, by a second computing device and a pre-trained second neural network model, characters in the first region based on the first region, so as to obtain the first question. An input of the second neural network model is the first region in the image where the first question is located (for example, the first region may be cut out from the complete image), and an output is the characters in the first region. It will be appreciated that the character referred to herein includes text (including textual word, graphic text, letters, numbers, symbols, etc.) as well as picture and the like.

The second neural network model may be trained in advance using a large number of training samples, in accordance with the above-described input and output, by any known method. For example, it may be trained by the following process: establishing an image sample training set, wherein each image sample includes at least one question. Labeling each image sample to mark characters in a region in each image sample where the at least one question is located; and training a second neural network through the labeled image sample training set so as to obtain the trained second neural network model. The second neural network may be any known neural network. In addition, similar to the description of the first neural network above, training the second neural network may further include verifying an output accuracy of the model with a test set, and increasing the number of samples in the test set if the accuracy does not meet the requirement so as to retrain the second neural network.

Step S14 may include determining, by a third computing device and a pre-trained third neural network model, a type of the first question based on the first question. The type of the question may include a calculation question, a math word question, a fill-in-the-blank question, a multiple-choice question, and an operation question. An input of the third neural network model is a question, and an output is a type of the question. The third neural network model may be obtained by pre-training a third neural network by any known method using a large number of training samples based on the above-mentioned input and output. The third neural network may be any known neural network, such as a deep convolutional neural network or the like.

If the type of the first question identified in step S14 is a calculation question, steps S151 and S152 are performed. Step S151 may include generating a first answer and a step-by-step problem solving process of the calculation question by fourth and fifth computing devices, respectively. The first answer is a reference answer for assisting with the math problem generated by the method of the present invention. The fourth computing device for generating the first answer may be any known calculation engine.

Generating the step-by-step problem solving process of the calculation question by the fifth computing device may include: acquiring a corresponding rule from a preset rule base according to a formal feature of the first question (for example, the number of unknowns, the number of squares, the position, the calculation symbol, etc.); and generating the step-by-step problem solving process according to the corresponding rule. The following is a specific example.

For example, if the identified calculation question is

$$\frac{x \vert 4}{3} = \frac{x \vert 5}{5} ,$$

then the formal feature of the question is determined to be a linear equation in one variable with a denominator. A rule corresponding to the linear equation in one unknown with a denominator is acquired from a preset rule base. For example, the acquired rule may sequentially include the following five steps: canceling denominator(s), canceling bracket(s), transposing, uniting similar terms, and normalizing a coefficient. Then according to the rule including these five steps, the following step-by-step problem solving process may be generated:

1. canceling denominator(s) so as to get: 5(x+4)=3(x+5);

2. canceling bracket(s) so as to get: 5x+20=3x+15;

3. transposing so as to get: 5x−3x=15−20;

4. uniting similar terms so as to get: 2x=−5;

5. normalizing a coefficient so as to get: x=−5/2.

It should be noted that, as is well known, in the example of the above-described step-by-step problem solving process, the step of canceling denominator(s) is usually to multiply both sides of the equation by the least common multiple of the two denominators (for example, in the above example, the least common multiple of the denominators 3 and 5 is 15). If the denominator is a fraction (including decimals), the step of canceling denominator(s) may include two sub-steps: first canceling the fraction in the denominator (for example, the numerator and the denominator are both multiplied by the reciprocal of the denominator), and then multiplying both sides of the equation by the least common multiple of the two denominators.

Take the equation

$$\frac{x}{0.2} = \frac{x + 1}{\frac{3}{4}}$$

as an example, canceling the fraction in the denominator may include the numerator and the denominator on the left side of the equation are multiplied by the reciprocal 5 of the denominator on the left side of the equation, and the numerator and denominator on the right side of the equation are multiplied by the reciprocal 4/3 of the denominator on the right side of the equation. Then the equation becomes 5x=4/3(x+1). Multiply both sides of the equation by the least common multiple 3 of the two denominators and the equation becomes 15x=4(x+1). The result of the step of canceling denominator(s) in the step-by-step problem solving process of the above example is thus obtained.

Step S152 may include displaying, by a display device in a second electronic device, the question of the calculation question and/or the first region, and displaying the first answer and the step-by-step problem solving process. The first and second electronic devices may be the same device or different devices. That is to say, the image capturing device and the display device may be located in the same electronic device or in different electronic devices. An illustrative example of the display screen (screen 100) of the display device may be referred to FIG. 1A.

The screen 100 includes a title 106 which indicates the screen 100 displaying a solution of a math problem, a question 101 of the calculation question that is identified by the second computing device and the second neural network model, an image region 107 where the question of the calculation question is located that is identified by the first computing device and the first neural network model, an answer 102 of the calculation question generated by the fourth computing device, and a step-by-step problem solving process 108, 109 generated by the fifth computing device. Although the question 101 of the calculation question and its image area 107 are both displayed in the screen 100 in the example shown in FIG. 1A, those skilled in the art will appreciate, in other embodiments, that one of the question 101 of the calculation question and its image area 107 may be displayed, or none of the question 101 of the calculation question and its image area 107 may be displayed.

In some embodiments, considering the teaching/learning effect, the step-by-step problem solving process of the calculation question is displayed at time of the first trigger. For example, after getting the first answer (i.e., the reference answer) of the calculation question by viewing the display device, the user may first think about the steps of solving the problem, and then trigger the display device, for example, by operating a specific operating device of the second electronic device, a specific area in the display screen of the display device or the like, to display the step-by-step problem solving process when the user needs to view the step-by-step problem solving process. For example, the method of the present invention may display only the question 101 of the calculation question and the first answer 102 by default; the step-by-step problem solving process 108, 109 is displayed at the time of a specified first operation (for example, a light touch, two consecutive touches, a long press, a deep press, a tap, a slide, a swipe etc.) being performed on at least one of: the area where the question 101 of the calculation question is located, the area where the image area 107 is located, the area where the first answer 102 of the calculation question is located, a blank area 103, and other specified areas (for example, the area where the partial title 105 is located and the area where the title 106 is located) in the display screen 100 of the display device. It will be appreciated that the indications of other specified areas in the drawings are only schematic, and other specified areas may obviously include other areas not indicated or not shown in the drawings.

The step-by-step problem solving process may include one or more steps, each step corresponding to an operation, each operation typically having its name 108 (in the example shown in FIG. 1A, “subtract 2 from both sides”), its process 109-1 (in the example shown in FIG. 1A, the content shown in the box, labeled “How to do?”) and its result 109-2 (“x=1” in the example shown in FIG. 1A). Although not shown in the drawings, those skilled in the art will appreciate that the name 108, the process 109-1, and the result 109-2 may not all be displayed as long as one of them is displayed, or any two of them are displayed. As an example, at time of the first trigger, the screen 100 may display the name 108 and the result 109-2 of the operation corresponding to each step by default as an assistance to the user with the calculation question. When the user wishes to know more about the content of the operation, such as how to obtain the result 109-2, a specified area (e.g., the area where the special marker 104 is located) may be operated (e.g., tapped) to trigger the process 109-1 of the operation to be displayed.

In some embodiments, if the type of the first question identified in step S14 is a calculation question, a graphical problem solving process of the calculation question may be generated by a sixth computing device, and the question of the calculation question and/or the first region, the first answer and the graphical problem solving process are displayed, by the display device at time of a second trigger. An illustrative example of the display screen (screen 200) of the display device may be referred to FIG. 1B. Since the graphical problem solving process 204 is more intuitive and easier to understand, displaying a graphical problem solving process is more conducive to the assistance effect of the math problem. For the similar considerations of the above-described about the step-by-step problem solving process, the graphical problem solving process may be displayed at time of the second trigger. For example, the graphical problem solving process 204 is displayed at the time of a specified second operation (for example, a light touch, two consecutive touches, a long press, a deep press, a tap, a slide, a swipe etc.) being performed on at least one of: the area where the question 201 of the calculation question is located, the area where the image area (not shown) is located, the area where the first answer 202 of the calculation question is located, a blank area 203, and other specified areas (for example, the area where the partial title 205 is located and the area where the title 206 is located) in the display screen 200 of the display device.

In some embodiments, the method of the present invention may display only the question of the calculation question and the first answer by default, display the step-by-step problem solving process at the first trigger, and display the graphical problem solving process at the second trigger. In some embodiments, the method of the present invention may display the question of the calculation question, the first answer, and the step-by-step problem solving process by default, and display the graphical problem solving process at the second trigger. In some embodiments, the method of the present invention may display the question of the calculation question, the first answer, and the graphical problem solving process by default, and display the step-by-step problem solving process at the first trigger.

Generating the graphical problem solving process of the calculation problem by the sixth computing device may include: converting the calculation question into a function graph based on the plotly library or a PM algorithm model; and generating a graphical problem solving process of the calculation question based on the function graph. The following is an example to illustrate the graphical problem solving process.

For example, in the example shown in FIG. 1B, the question of the calculation question is x+2=3. A group of two linear equations each in two unknowns may be established according to the question, that is, two equations y=x+2 and y=3. Then function graphs in a Cartesian coordinate system may be obtained by converting these two equations using a plotly library and/or a PM algorithm model. For example, y=x+2 is converted into a straight line with a slope of 1 and an intercept of 2, and y=3 is converted into a straight line with an intercept of 3 parallel to the x-axis. It can be seen from the function graph in the Cartesian coordinate system that the answer of the question is the intersection of two straight lines, i.e., x=1. For another example, for a quadratic equation in two unknowns, it is known that its function graph is a parabola curve, and the intersections of the parabola curve and one of the coordinate axes is the answer of the question. Therefore, the method may first determine the answer of the question and then determine the function graph. For example, for the equation y=2x²−5x+2, it is known that the dependent variable y is a function of the independent variable x; the method may first obtain the two answers of the question by the cross multiplication method as x=0.5 and x=2, so the intersections of the parabola curve and the x-axis may be determined as 0.5 and 2; and the opening of the parabola curve is determined to be upward according to the sign (positive or negative) of the coefficient of the quadratic variable. Therefore, the function graph may be easily determined and plotted using the plotly library or the PM algorithm model.

In some embodiments, the method for assisting with a math problem according to an embodiment of the present invention may further correct a second answer (e.g., may be a user answer to the first question) associated with the first question that is presented on the first surface. In these cases, by the first computing device and the first neural network model, the first region in the image where the first question is located and the second region where the second answer is located are identified based on the image including the first question of the math problem and the second answer associated with the first question that are presented on the first surface. Characters in the first region are identified, by a second computing device and the second neural network model, based on the first region so as to obtain the first question. Characters in the second region are identified, by a seventh computing device and a pre-trained fourth neural network model, based on the second region, so as to obtain the second answer. The first and second answers are compared, by an eighth computing device, so as to obtain a conclusion indicating whether the first and second answers are identical or not, that is, whether the second answer is correct or not. The first question, the first answer, the second answer, the conclusion and the step-by-step problem solving process are displayed by the display device. The conclusion indicating whether the second answer is correct or not may be displayed by a specific symbol (for example, “√” or “x”), or may displayed by a specific mark that indicate that the second answer (e.g., user answer) is different from the first answer (e.g., reference answer).

The training method of the fourth neural network model may be similar to the training method of the second neural network model. In some embodiments, in view of the font of the first question being a print and the font of the second answer is a handwriting (because it may be an answer handwritten by the user), so the second neural network model for identifying characters in the first region and the fourth neural network model for identifying characters in the second region may be different models that are trained separately. However, it will be appreciated that the second neural network model and the fourth neural network model may be the same model.

If the type of the first question identified in step S14 is a math word question, steps S161 to S164 are performed. Step S161 may include extracting, by a ninth computing device and a pre-trained fifth neural network model, features of the math word question so as to generate a two-dimensional feature vector. The two-dimensional feature vector may be a feature map, which may be generated by any method known in the art, for example, by using a deep convolutional neural network to process the image region where the math word question is located. A first two-dimensional feature vector is generated for a text in the math word question, and a second two-dimensional feature vector is generated for a picture in the math word question; and the first and second two-dimensional feature vectors are combined to obtain the two-dimensional feature vector. An input of the fifth neural network model is a first question (including a text and a picture), and an output is a two-dimensional feature vector corresponding to the first question (combined by first and second two-dimensional feature vectors). The fifth neural network model may be obtained by pre-training the fifth neural network by any known method using a large number of training samples according to the above-mentioned input and output. The fifth neural network may be any known neural network, such as a deep convolutional neural network or the like.

Step S162 may include searching, by a tenth computing device, a question vector matching the two-dimensional feature vector (for example, a vector closest to the first question) from a preset vector index library. The vector index library includes a plurality of groups, each group including one or more vectors. These vectors are two-dimensional feature vectors generated by extracting features on those known math word questions (e.g., questions in a library that are collected in advance). Any two vectors from the same group have the same length, and any two vectors from two different groups have different lengths.

Searching the question vector from the vector index library may include: first finding a group matching the length of the two-dimensional feature vector in the vector index library according to the length of the two-dimensional feature vector; and then searching in the group matching the length so as to find the question vector. In this way, the question vector matching the two-dimensional feature vector may be found more quickly. In some embodiments, each group has a respective index that matches (e.g., equal to) the length of each vector in the group, and finding the group in the vector index library that matches the length of the two-dimensional feature vector includes: finding the group according to the index of each group.

Step S163 may include generating, by an eleventh computing device, a fourth answer (i.e., a reference answer) of the math word question according to a preset third answer associated with the question vector of the math word question; and step S164 may include displaying the fourth answer of the math word question by the display device. The third answer may be from a math word question bank that is collected in advance. For example, the question bank includes questions and reference answers corresponding to the questions. After finding the vector closest to the first question (i.e., the closest question matching the question vector) in step S162, the answer associated with the closest question is extracted from the question bank, which is the third answer. Then, using the third answer as a template, the third answer is transformed according to the difference between the first question and the closest question so as to obtain a fourth answer.

Each of the pre-trained first through fifth neural network models may be collectively stored on one or more storage media of any of the followings, or a first portion of the five models may be stored on one or more storage media of any of the followings and a second portion of the five models may be stored on one or more storage media of any other of the followings: first and/or second electronic device, one or more remote servers, on one or more of the first through eleventh computing devices.

Any two of the first through eleventh computing devices that perform the above-described respective steps may be the same computing device or different computing devices. Each of the first through eleventh computing devices may include one or more processors, and one or more processors belonging to one computing device may be located collectively within the physical housing of the first and/or second electronic device, collectively within the physical housing of one or more remote servers, or a first portion thereof is located within the physical housing of the first and/or second electronic device and a second portion thereof is located within the physical housing of one or more remote servers. It will be appreciated that each of the first through eleventh computing devices may further include one or more memories to store instructions executable by the one or more processors and data required to execute the instructions, such as at least a portion of the one or more neural network models above.

The method for assisting with a math problem according to above embodiments of the present invention provides a procedure of processing a single question (a calculation question or a math word question). The method for assisting with a math problem according to other embodiments of the present invention may jointly process multiple questions in the entire test paper. It will be appreciated that the procedure of processing a single question in the above embodiment is also applicable to the procedure of jointly processing multiple questions. For the sake of brevity, the procedure similar to the above will not be duplicated described in the following description.

The image of the substantially entire test paper is acquired by the image capturing device in the first electronic device. The entire test paper includes a plurality of questions, and the types of the plurality of questions may be the same or different. A type of a question may include a calculation question, a math word question, a fill-in-the-blank question, a multiple-choice question, and an operation question. A plurality of respective regions where a plurality of questions in the image are located are identified by the first computing device and the first neural network model. The respective characters in the plurality of regions are respectively identified by the second computing device and the second neural network model, so as to obtain a plurality of questions included in the image of the entire test paper. The type of each of the plurality of questions is determined by the third computing device and the third neural network model. For each of the identified calculation questions in the entire test paper, the operations of steps S151 and S152 as described above may be performed. For each of the identified math word questions in the entire test paper, the operations of steps S161 through S164 as described above may be performed.

It will be appreciated that if the test paper also includes a user answer, the method may also identify the region where the user answer to each question is located while identifying the region where each question is located. Then, through the corresponding model, the characters in the region where each answer is located are identified, and the answers in the entire test paper are corrected by comparing the user answer and the reference answer.

In some embodiments, determining the type of each of the plurality of questions is based on each question (e.g., text and pictures included in the question, etc.) and the location of each question in the entire test paper (e.g., the location of the region where each question is located in the image of the entire test paper). For some test papers, the distribution of question types is relatively fixed. For example, the calculation questions are arranged at the beginning of the test paper, followed by multiple-choice questions or fill-in-the-blank questions, and finally the math word questions and operation questions. Therefore, the location of the question in the entire test paper is considered when identifying the type of the question, which is advantageous for the identifying accuracy. The location may be a detailed location, such as a coordinate; or a rough location, such as which part of the test paper is located (e.g., upper left part, right middle part, etc.); or may be a question order, such as being located in a part of the first chapter of the entire test paper, or the like. In these embodiments, an input to the third neural network model is each question, and a corresponding location of each question in the entire test paper, and an output is the type of each question. In the image samples used to train the third neural network model, the location of each question in the sample, the location of the answer and the type of the question are labeled.

In some embodiments, using the first neural network model, identifying the plurality of regions where the plurality of questions in the image are located includes extracting a two-dimensional feature vector of the entire test paper using a deep convolutional neural network. An anchor (also referred to as an anchor box) of a shape is generated for each mesh of the two-dimensional feature vector. Each anchor includes the center coordinates of the label box and the length and height of the label box. Since the text lines in the test paper are mostly long strips, multiple anchors may be defined in advance, e.g., including rectangular boxes with aspect ratios of 2:1, 3:1, 4:1, and other ratios. The identified region of each question is labeled with a rectangular box in an appropriate shape.

When training the first neural network model, the image samples used (for the input of the model during training) include ground truth boxes (for example, may be manually labeled) that marks each question in the sample and its answer. Among them, the ground truth boxes are labeled respectively for the picture and the text in the question. During the training process, the generated anchors are regressed with the ground truth boxes, so that the labeled boxes are closer to the real locations of the questions or answers, and the first neural network model may further identify the region where each question is located accurately.

The question is typically a printed font, and the user answer is usually a handwritten font; and especially for a math word question, the character set contained in the question is often different from the character set contained in the answer. The character set contained in the answer is typically smaller than the character set contained in the question. For example, the characters in the user answer typically include frequently-used Chinese characters and numbers, letters, and symbols. In view of this, in some embodiments, different models may be used to identify the characters in the question and the answer, and the two models may be trained with different sets of training image samples, respectively. Nevertheless, the method of identifying by the model may use hole convolution to extract features from characters (including text and pictures), so that the extracted features have a relatively large receptive field. Using the hole convolution may be identifying according to the context of handwritten text, or may be identified by interval without word-by-word, which is convenient for machine parallel processing. The feature is then decoded by an attention model, and finally the variable length text may be output.

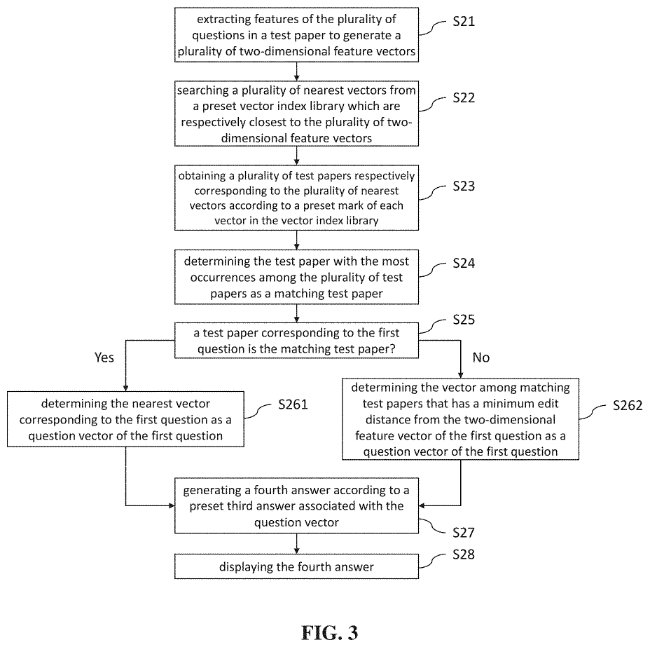

For the math word questions in the entire test paper, in order to make the result of the question search more accurate, in some embodiments, the method of the present invention further includes the process as shown in FIG. 3. Step S21 may include performing feature extraction on the regions of the plurality of math word questions {T1, T2, . . . , Tn} in the image by the ninth computing device and the fifth neural network model so as to generate a plurality of two-dimensional feature vectors {a1, a2, . . . , an}. Step S22 may include searching, by the tenth computing device, a plurality of nearest vectors {b1, b2, . . . , bn} that are respectively closest to the plurality of two-dimensional feature vectors from the preset vector index library. Step S23 may include according to a preset mark of each vector in the vector index library (the mark of each vector may be an identification ID of the test paper where the vector is from), obtaining a plurality of test papers {P1, P2, . . . , Pn} that are respectively corresponding to the plurality of nearest vectors. Step S24 may include determining the test paper with the most occurrences among the plurality of test papers as a matching test paper P. Step S25 may include determining, for each of the plurality of questions, whether the test paper corresponding to the nearest vector that is closest to the two-dimensional feature vector of each question is a matching test paper. Taking the question T1 as an example, it is determined that whether the test paper P1 corresponding to the nearest vector b1 that is closest to the two-dimensional feature vector a1 of the question T1 is the matching test paper P. If yes, step S261 will be performed that includes determining the closest vector b1 that is closest to the two-dimensional feature vector a1 of the question T1 as the question vector t of the question T1. If not, step S261 will be performed that includes: performing a short edit distance matching on the two-dimensional feature vector a1 of the question T1 among a plurality of vectors having marks of the identification ID of the matching test paper P, finding a vector s of the plurality of vectors that has a minimum edit distance from the two-dimensional feature vector a1 of the question T1, and determining the vector s having the minimum edit distance as the question vector t of the question T1. Step S27 may include generating the fourth answer (i.e., the reference answer) of the question T1 by the eleventh computing device according to a preset third answer (for example, a template answer) associated with the question vector t of the question T1. Step S28 may include displaying the fourth answer of the math word questions through the display device.

In some embodiments, if it is determined in step S25 that the test paper corresponding to the nearest vector that is closest to the two-dimensional feature vector of a certain question is not a matching test paper, for example, the test paper P1 corresponding to the nearest vector b1 that is closest to the two-dimensional feature vector a1 of the question T1 is not the matching test paper P, the following processes are performed rather than the above step S262. One or more question vectors matching the two-dimensional feature vector a1 of the question T1 are searched from a preset vector index library. The vector index library may be as described above. A matching threshold may be set for such a search so that N matching question vectors whose matching degree is greater than the matching threshold may be found. Since the conversion algorithm when converting the question to a two-dimensional feature vector (such as the known word2vec conversion model, doc2vec conversion model, etc.) usually sets a lower weight to the number in the question, the text portion (here refers to the non-numeric part of the text portion) of the question is usually matching well, and the numeric portion may be mismatched. This means that the question corresponding to the matching question vector and the currently processed question are substantially identical or similar in the text representation (may be understood as the same question type), and the number need to be calculated may be different. Then, the identified characters of the currently processed question is compared with the characters of the N matching question vectors (for example, text or characters comparison of some known text/characters comparison tools), and then the N matching question vectors are sorted according to the comparison result (e.g., matching degrees) so as to find the most matching question with the currently processed question. Then, referring to step S163, a reference answer of the currently processed question (which may be similar to the fourth answer in step S163) is calculated based on the answer of the most matching question (which may be similar to the third answer in step S163). Then, step S28 may be performed to display the reference answer of the math word question (i.e., the currently processed question) through a display device.

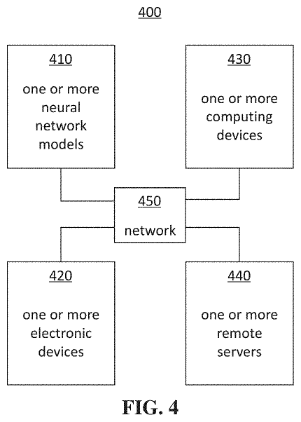

FIG. 4 is a block diagram that schematically illustrates at least a portion of a system 400 for assisting with a math problem in accordance with one embodiment of the present disclosure. Those skilled in the art will appreciate that system 400 is only an example and should not be considered as limiting the scope of the disclosure or the features described herein. In this example, system 400 may include one or more neural network models 410, one or more electronic devices 420, one or more computing devices 430, one or more remote servers 440, and a network 450. The one or more neural network models 410, the one or more electronic devices 420, the one or more computing devices 430, and the one or more remote servers 440 may be interconnected by the network 450. The network 450 may be any wired or wireless network, and may also include cables. Moreover, while the one or more neural network models 410 are separate in system 400 from the one or more electronic devices 420, the one or more computing devices 430, the one or more remote servers 440, and the network 450, it will be appreciated that the one or more neural network models 410 may be physically stored on any of the other entities 420, 430, 440, 450 included in system 400.

For example, the one or more computing devices 430 may include a server computing device that operates as a load balanced server farm. Additionally, while some of the steps described above are indicated to occur on a single computing device, various aspects of the subject matter described herein may be implemented by a plurality of computing devices that are communicate for example through a network.

Each of the one or more electronic devices 420, the one or more computing devices 430, and the one or more remote servers 440 may be located at different nodes of the network 450 and may be directly or indirectly communicate with other nodes of the network 450. Those skilled in the art will appreciate that system 400 may further include other devices not shown in FIG. 4, with respective devices being located at respective nodes of network 450. The various protocols and systems may be used to interconnect the network 450 with the components of the system described herein such that the network 450 may be part of the Internet, the World Wide Web, a particular intranet, a wide area network, or a local area network. The network 450 may utilize standard communication protocols such as Ethernet, WiFi, and HTTP, proprietary protocols for one or more companies, and various combinations of the foregoing. While certain advantages are obtained when communicating or receiving information as described above, the subject matter described herein is not limited to any particular manner of information transfer.

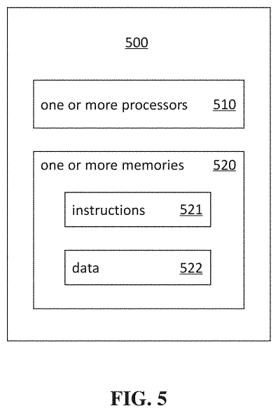

Each of the one or more electronic devices 420, the one or more computing devices 430, and the one or more remote servers 440 may be configured similar to the system 500 illustrated in FIG. 5, having one or more processors 510, one or more memories 520, and instructions and data. Each of the one or more electronic devices 420, the one or more computing devices 430, and the one or more remote servers 440 may be a personal computing device intended for use by a user or a commercial computing device used by an enterprise, and having all components typically used in conjunction with personal computing devices or commercial computer devices, such as central processing units (CPUs), memories that store data and instructions (e.g., RAM and internal hard drives), and one or more I/O devices such as displays (e.g., a monitor with a screen, a touch screen, a projector, a television, or another device operable to display information), a mouse, a keyboard, a touch panel, a microphone, a speaker, and/or a network interface device. The one or more electronic devices 420 may further include one or more cameras for capturing still images or recording video streams and all components for connecting these elements to each other.

While the one or more electronic devices 420 may each include a full size personal computing device, they may optionally include a mobile computing device capable of wirelessly exchanging data with a server over a network such as the Internet. For example, the one or more of the electronic devices 420 may be a mobile phone, or a device such as a PDA with wireless support, a tablet PC, or a netbook capable of obtaining information via the Internet. In another example, the one or more electronic devices 420 may be a wearable computing system.

FIG. 5 is a block diagram that schematically illustrates at least a portion of a system 500 for assisting with a math problem in accordance with one embodiment of the present disclosure. The system 500 includes one or more processors 510, one or more memories 520, and other components (not shown) that are typically found in devices such as computers. Each of the one or more memories 520 may store content accessible by the one or more processors 510, including instructions 521 that are executable by the one or more processors 510, and data that may be retrieved, manipulated, or stored by the one or more processors 510.

Instruction 521 may be any set of instructions to be directly executed by the one or more processors 510, such as machine code, or any set of instructions, such as scripts, executed indirectly. The terms “instructions,” “applications,” “procedures,” “steps,” and “programs” are used interchangeably herein. The instructions 521 may be stored as a target code format for direct processing by the one or more processors 510, or stored as any other computer language, including scripts or collections of independent source code modules that are interpreted on demand or compiled in advance. The instructions 521 may include instructions that cause the one or more processors 510 to act as the neural networks herein. The remainder of this document explains the functions, methods, and routines of the instruction 521 in more detail.

The one or more memories 520 may be any temporary or non-transitory computer readable storage medium capable of storing content accessible by the one or more processors 510, such as a hard drive, a memory card, a ROM, a RAM, a DVD, a CD, USB memory, write-enabled memory, read-only memory, etc. One or more of the one or more memories 520 may include a distributed storage system, wherein the instructions 521 and/or the data 522 may be stored on a plurality of different storage devices that may be physically located at the same geographic location or different geographic locations. One or more of the one or more memories 520 may be connected to one or more processors 510 via a network, and/or may be directly coupled to or incorporated in any one of the one or more processors 510.

The one or more processors 510 may retrieve, store, or modify the data 522 in accordance with the instructions 521. The data 522 stored in the one or more memories 520 may include various images to be identified, various image sample sets, parameters for individual neural networks, and the like as described above. Other data not associated with the images or neural networks may also be stored in the one or more memories 520. For example, although the subject matter described herein is not limited by any particular data structure, the data 522 may also be stored in computer registers (not shown) as a table or XML document having many different fields and records stored in a relationship database. The data 522 may be formatted into any computing device readable format such as, but not limited to, binary values, ASCII, or Unicode. Moreover, the data 522 may include any information sufficient to identify relevant information, such as numbers, descriptive text, a proprietary code, a pointer, references to data stored in other memories such as at other network locations, or information used by a function for computing related data.

The one or more processors 510 may be any conventional processor, such as a commercially available central processing unit (CPU), graphics processing unit (GPU), and the like. Alternatively, the one or more processors 510 may also be dedicated components such as an application specific integrated circuit (ASIC) or other hardware based processor. Although not required, the one or more processors 510 may include specialized hardware components to perform particular computing processes, such as image processing of images, etc., faster or more efficiently.

Although the one or more processors 510 and one or more memories 520 are shown schematically in the same block (that indicates the system 500) in FIG. 5, the system 500 may actually include multiples processors or memories that may exist within the same physical housing or within different physical housings. For example, one of the one or more memories 520 may be a hard drive or other storage located in a housing other than the housing of each of the one or more computing devices (not shown) described above. Thus, reference to a processor, a computer, a computing device, or a memory will be understood as including references to a set of processors, computers, computing devices, or memories that may be operated in parallel or not.

The term “A or B” used through the specification refers to “A and B” and “A or B” rather than meaning that A and B are exclusive, unless otherwise specified.

In the present disclosure, a reference to “one embodiment”, “an embodiment” or “some embodiments” means that features, structures, or characteristics described in connection with the embodiment(s) are included in at least one embodiment, at least some embodiments of the present disclosure. Thus, the phrases “in an embodiment” and “in some embodiments” in the present disclosure do not mean the same embodiment(s). Furthermore, the features, structures, or characteristics may be combined in any suitable combination and/or sub-combination in one or more embodiments.

The term “exemplary”, as used herein, means “serving as an example, instance, or illustration”, rather than as a “model” that would be exactly duplicated. Any implementation described herein as exemplary is not necessarily to be construed as preferred or advantageous over other implementations. Furthermore, there is no intention to be bound by any expressed or implied theory presented in the preceding technical field, background, summary or detailed description.

The term “substantially”, as used herein, is intended to encompass any slight variations due to design or manufacturing imperfections, device or component tolerances, environmental effects and/or other factors. The term “substantially” also allows for variation from a perfect or ideal case due to parasitic effects, noise, and other practical considerations that may be present in an actual implementation.

In addition, the foregoing description may refer to elements or nodes or features being “connected” or “coupled” together. As used herein, unless expressly stated otherwise, “connected” means that one element/node/feature is electrically, mechanically, logically or otherwise directly joined to (or directly communicates with) another element/node/feature. Likewise, unless expressly stated otherwise, “coupled” means that one element/node/feature may be mechanically, electrically, logically or otherwise joined to another element/node/feature in either a direct or indirect manner to permit interaction even though the two features may not be directly connected. That is, “coupled” is intended to encompass both direct and indirect joining of elements or other features, including connection with one or more intervening elements.

In addition, certain terminology, such as the terms “first”, “second” and the like, may also be used in the following description for the purpose of reference only, and thus are not intended to be limiting. For example, the terms “first”, “second” and other such numerical terms referring to structures or elements do not imply a sequence or order unless clearly indicated by the context.

Further, it should be noted that, the terms “comprise”, “include”, “have” and any other variants, as used herein, specify the presence of stated features, integers, steps, operations, elements, and/or components, but do not preclude the presence or addition of one or more other features, integers, steps, operations, elements, components, and/or groups thereof.

In the present disclosure, the terms “component” and “system” are intended to refer to a computer-related entity, or a hardware, a combination of a hardware and a software, a software, or an executing software. For example, a component may be, but not limited to, a process running on a processor, an object, an executing state, an executable thread, and/or a program, etc. By way of example, either an application running on one server or the server may be a component. One or more components may reside within an executing process and/or thread, and a component may be located on a single computer and/or distributed between two or more computers.

Furthermore, those skilled in the art will recognize that boundaries between the above described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. However, other modifications, variations and alternatives are also possible. The description and drawings are, accordingly, to be regarded in an illustrative rather than in a restrictive sense.

Although some specific embodiments of the present disclosure have been described in detail with examples, it should be understood by a person skilled in the art that the above examples are only intended to be illustrative but not to limit the scope of the present disclosure. The embodiments disclosed herein can be combined arbitrarily with each other, without departing from the scope and spirit of the present disclosure. It should be understood by a person skilled in the art that the above embodiments can be modified without departing from the scope and spirit of the present disclosure. The scope of the present disclosure is defined by the attached claims.

What is claimed is:

1. A method for assisting with a math problem comprising:
acquiring, by an image capturing device, an image including at least a first question of the math problem;
identifying, by a first computing device and a pre-trained first neural network model, a first region in the image where the first question is located based on the image;
identifying, by a second computing device and a pre-trained second neural network model, characters in the first region based on the first region, so as to obtain the first question;
determining, by a third computing device and a pre-trained third neural network model, a type of the first question based on the first question;
if the type of the first question is a calculation question,
generating, by a fourth computing device, a first answer of the calculation question, and generating, by a fifth computing device, a step-by-step problem solving process of the calculation question; and
displaying, by a display device, the first question and/or the first region, and displaying, by a display device, the first answer and the step-by-step problem solving process.

2. The method according to claim 1, wherein the generating, by the fifth computing device, the step-by-step problem solving process comprises:
acquiring a corresponding rule from a preset rule base according to a formal feature of the first question; and
generating the step-by-step problem solving process according to the corresponding rule.

3. The method according to claim 1, wherein the step-by-step problem solving process comprises one or more steps, and the displaying, by the display device, the step-by-step problem solving process comprises: displaying a result of an operation of each of the one or more steps.

4. The method according to claim 3, wherein the displaying, by the display device, the step-by-step problem solving process further comprises: displaying a name and/or a process of the operation of each of the one or more steps in an area of a display screen that is associated with the result of the operation of each of the one or more steps.

5. The method according to claim 1, wherein the step-by-step problem solving process is displayed at the time of a specified first operation being performed on at least one of: an area where the first question is located, an area where the first answer is located, a blank area, and another specified area in a display screen of the display device.

6. The method according to claim 1, further comprising if the type of the first question is the calculation question,
converting, by a sixth computing device, the calculation question into a function graph, and generating a graphical problem solving process of the calculation question based on the function graph; and
displaying, by the display device, the graphical problem solving process.

7. The method according to claim 6, wherein the graphical problem solving process is displayed at the time of a specified second operation being performed on at least one of: an area where the first question is located, an area where the first answer is located, a blank area, and another specified area in a display screen of the display device.

8. The method according to claim 1, wherein the image further comprises a second answer associated with the first question, the method further comprising:
identifying, by the first computing device and the first neural network model, a second region where the second answer is located based on the image;
identifying, by a seventh computing device and a pre-trained fourth neural network model, characters in the second region based on the second region, so as to obtain the second answer; and
if the type of the first question is the calculation question,
comparing, by an eighth computing device, the first and second answers so as to obtain a conclusion indicating whether the first and second answers are identical or not; and
displaying, by the display device, the second answer and the conclusion.

9. The method according to claim 1, wherein the image comprises a substantially entire test paper where the first question is located, wherein the determining the type of the first question is further based on a location of the first region on the entire test paper.

10. The method according to claim 9, wherein the entire test paper further comprises a plurality of second questions other than the first question, types of the second questions are math word questions, and the method further comprises:
identifying, by the first computing device and the first neural network model, a plurality of third regions where the plurality of second questions are located based on the image;
identifying, by the second computing device and the second neural network model, respective characters in the plurality of third regions based on the plurality of third regions, so as to obtain the plurality of second questions;
if the type of the first question is a math word question,
extracting, by a ninth computing device and a pre-trained fifth neural network model, features of the first question and the plurality of second questions so as to generate a plurality of two-dimensional feature vectors;
searching, by a tenth computing device, a plurality of nearest vectors from a preset vector index library, wherein the plurality of nearest vectors are respectively closest to the plurality of two-dimensional feature vectors;
obtaining, by a tenth computing device, a plurality of test papers respectively corresponding to the plurality of nearest vectors according to a preset mark of each vector in the vector index library, wherein the mark is an identification of a test paper where the vector is from;
determining, by a tenth computing device, the test paper with the most occurrences among the plurality of test papers as a matching test paper;
if a test paper corresponding to one of the plurality of nearest vectors is the matching test paper and the one of the plurality of nearest vectors is closest to the two-dimensional feature vector corresponding to the first question, determining, by a tenth computing device, the one of the plurality of nearest vectors as a question vector of the first question;
if a test paper corresponding to one of the plurality of nearest vectors is not the matching test paper and the one of the plurality of nearest vectors is closest to the two-dimensional feature vector corresponding to the first question, performing, by a tenth computing device, a short edit distance matching on the two-dimensional feature vector of the first question among a plurality of vectors having marks of the matching test paper, finding, by a tenth computing device, one of the plurality of vectors that has a minimum edit distance from the two-dimensional feature vector of the first question, and determining, by a tenth computing device, the one of the plurality of vectors as the question vector of the first question;
generating, by an eleventh computing device, a fourth answer of the first question according to a preset third answer associated with the question vector of the first question; and
displaying, by the display device, the fourth answer.

11. A system for assisting with a math problem comprising:
one or more neural network models that are pre-trained;
one or more image capturing devices configured to acquire an image including at least a first question of the math problem;
one or more computing devices configured to:
identify a first region in the image where the first question is located based on at least one of the one or more neural network models and the image;
identify characters in the first region so as to obtain the first question based on at least one of the one or more neural network models and the first region;
determine a type of the first question based on at least one of the one or more neural network models and the first question; and
generate a first answer and a step-by-step problem solving process of the calculation question if the type of the first question is a calculation question, and
one or more display devices configured to display the first question and/or the first region, and display the first answer and the step-by-step problem solving process.

12. The system according to claim 11, wherein the one or more computing devices are further configured to:
acquire a corresponding rule from a preset rule base according to a formal feature of the first question; and
generate the step-by-step problem solving process according to the corresponding rule.

13. The system according to claim 11, wherein the step-by-step problem solving process comprises one or more steps, and the one or more display devices are further configured to display a result of an operation of each of the one or more steps.

14. The system according to claim 13, wherein the one or more display devices are further configured to display a name and/or a process of the operation of each of the one or more steps in an area of a display screen that is associated with the result of the operation of each of the one or more steps.

15. The system according to claim 11, wherein the one or more display devices are further configured to display the step-by-step problem solving process at the time of a specified first operation being performed on at least one of: an area where the first question is located, an area where the first answer is located, a blank area, and another specified area in a display screen of the display device.

16. The system according to claim 11, wherein
the one or more computing devices are further configured to if the type of the first question is the calculation question, convert the calculation question into a function graph, and generate a graphical problem solving process of the calculation question based on the function graph; and
the one or more display devices are further configured to display the graphical problem solving process.

17. The system according to claim 16, wherein the one or more display devices are further configured to display the graphical problem solving process at the time of a specified second operation being performed on at least one of: an area where the first question is located, an area where the first answer is located, a blank area, and another specified area in a display screen of the display device.

18. The system according to claim 11, wherein the image further comprises a second answer associated with the first question, and wherein
the one or more computing devices are further configured to:
identify a second region where the second answer is located based on at least one of the one or more neural network models and the image;
identify characters in the second region so as to obtain the second answer based on at least one of the one or more neural network models and the second region; and
compare the first and second answers if the type of the first question is the calculation question, so as to obtain a conclusion indicating whether the first and second answers are identical or not; and
the one or more display devices are further configured to display the second answer and the conclusion.

19. The system according to claim 11, wherein the image comprises a substantially entire test paper where the first question is located, and the one or more computing devices are further configured to determine the type of the first question further based on a location of the first region on the entire test paper.

20. A system for assisting with a math problem comprising:
one or more processors; and
one or more memories configured to store a series of computer executable instructions and one or more neural network models that are pre-trained,
wherein the series of computer executable instructions, when executed by the one or more processors, cause the one or more processors to perform:
acquiring an image including at least a first question of the math problem from an image capturing device;
identifying a first region in the image where the first question is located based on at least one of the one or more neural network models and the image;
identifying characters in the first region so as to obtain the first question based on at least one of the one or more neural network models and the first region;
determining a type of the first question based on at least one of the one or more neural network models and the first question;
if the type of the first question is a calculation question,
generating a first answer and a step-by-step problem solving process of the calculation question; and
sending the first question and/or the first region, the first answer and the step-by-step problem solving process to a display device.
